(19) United States
(12) Patent Application Publication
(10) Pub. No.: US 2025/0128539 A1
(43) Pub. Date: Apr. 24, 2025

(54) Painting Fixture Barrier

(71) Applicant: Cynthia Johnson, New York, NY (US)

(72) Inventor: Cynthia Johnson, New York, NY (US)

(21) Appl. No.: 18/990,570

(22) Filed: Dec. 20, 2024

Related U.S. Application Data
(60) Provisional application No. 63/545,101, filed on Oct. 20, 2023.

(51) Int. Cl. B44D 3/22; B05C 21/00

(52) U.S. Cl. CPC B44D 3/225; B05C 21/005

(57) ABSTRACT

The present invention provides a tool which serves as a barrier when painting around the edges of fixtures on a wall or ceiling. The barrier allows a painter to more precisely paint to the expected limit at the edge of a fixture with a dramatically reduced risk of applying paint to the fixture itself. The device is reusable, reducing the need for solutions involving consumables such as tape. Further, the device can be configured for flexibility that enable it to provide coverage against fixtures of more varied shapes and sizes more expediently than crafting customized solutions for every job.

### FIELD OF THE INVENTION

The present invention relates generally to the field of painting tools. Specifically, the invention is an apparatus for covering and protecting a fixture while painting.

### BACKGROUND OF THE INVENTION

When painting a wall or ceiling, there are often attached fixtures that must be carefully avoided during painting. These fixtures may be fans, light fixtures, audio equipment, smoke detectors, or various other furnishings and devices. In order to avoid getting paint on fixtures while painting the adjacent wall or ceiling, great care must be taken by the painter to precisely avoid painting fixtures, which greatly extends the time it takes to complete a painting project. The primary way in which painters protect fixtures while painting is by using tape and/or plastic coverings to line the edge of the fixtures and prevent paint from getting on the fixtures. However, while tape can be easily applied to flat surfaces such as wall trim or door frames, lining a circular fixture with tape requires precise application and can often result in inexact placement, leading to an imprecise line between wall and fixture.

The present invention overcomes the above referenced limitations of current methods and apparatuses for painting around fixtures by providing a precise and quickly deployable barrier between a fixture and a wall or ceiling for use during painting.

### BRIEF DESCRIPTION OF THE DRAWINGS

FIG. 1 is a top front perspective view for an embodiment of the present invention.

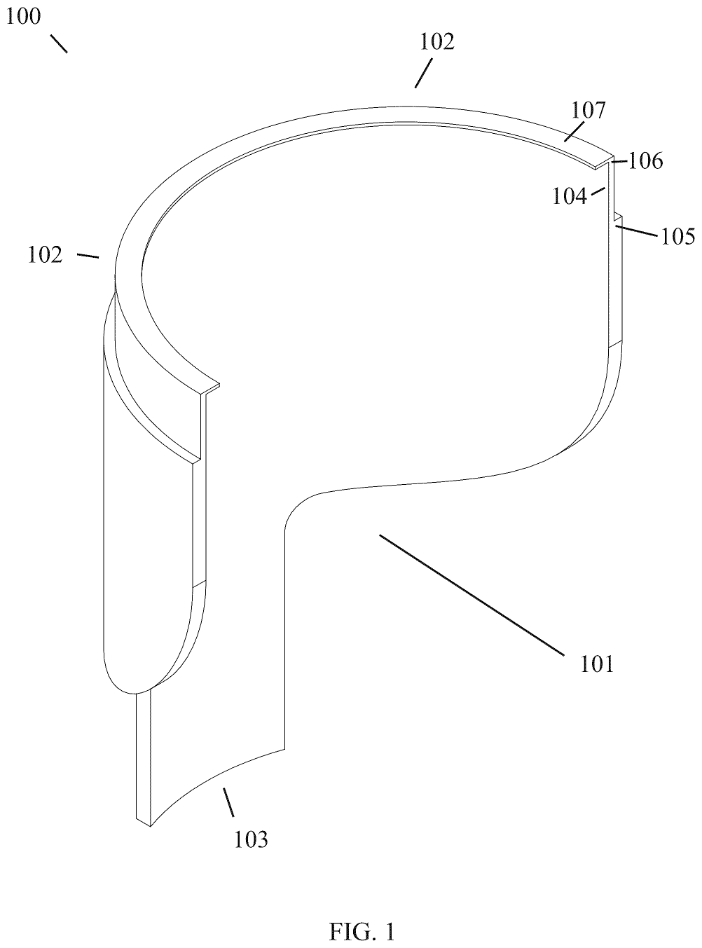

FIG. 2 is a bottom rear perspective view for an embodiment of the present invention.

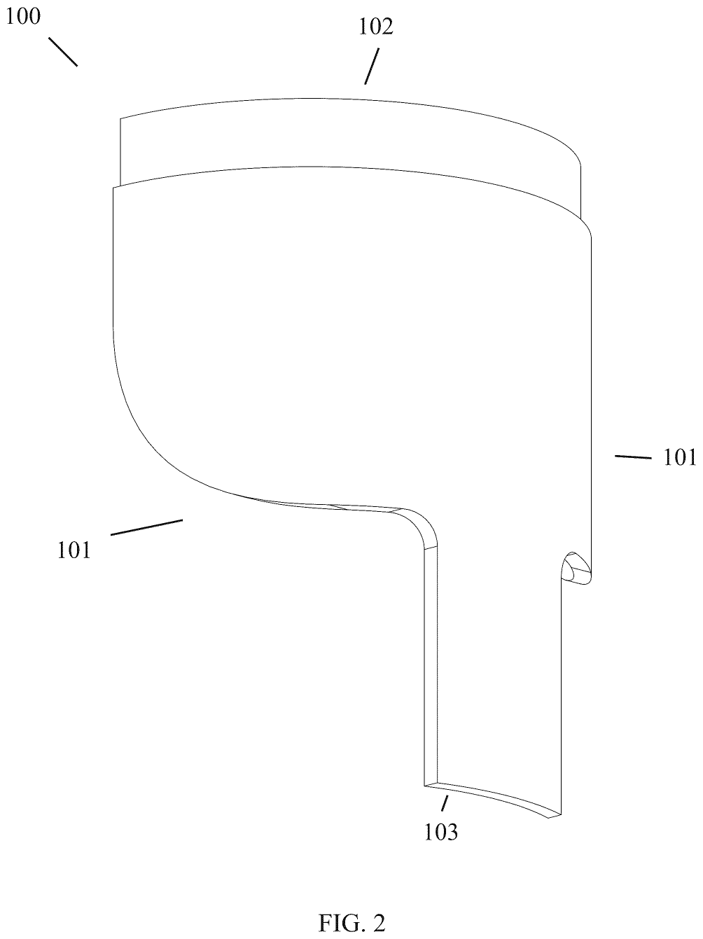

FIG. 3 is a front elevation view for an embodiment of the present invention.

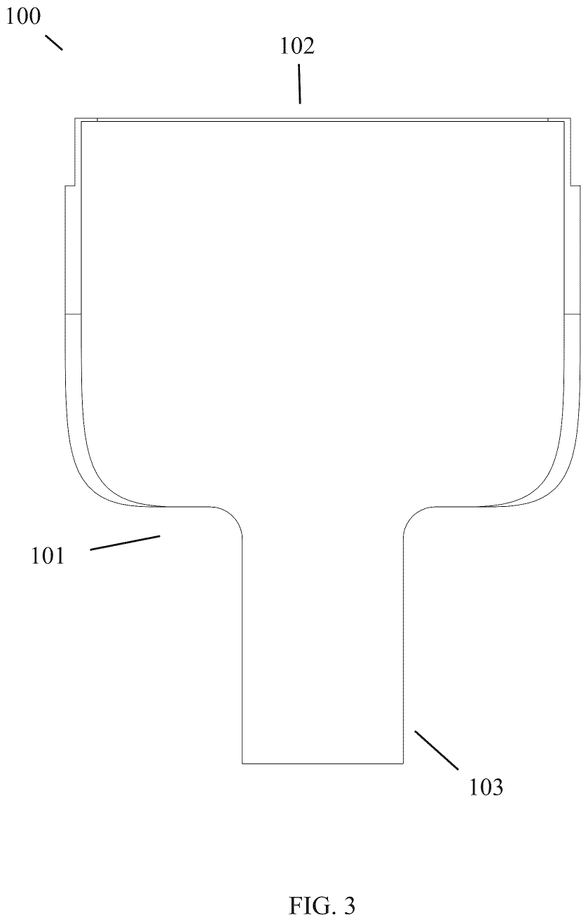

FIG. 4 is a left-side elevation view for an embodiment of the present invention.

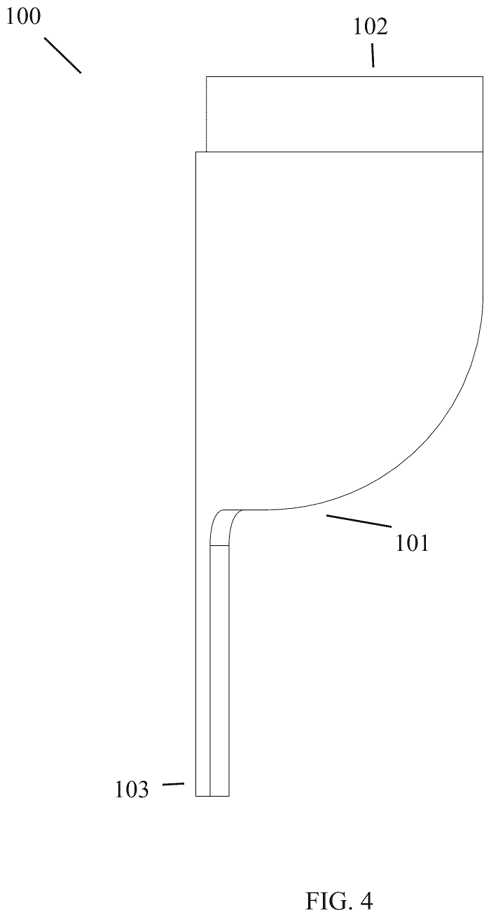

FIG. 5 is a top plan view for an embodiment of the present invention.

FIG. 6 is a top front perspective view for an embodiment of the present invention, wherein a tapered fixture edge has been incorporated without a flat barrier.

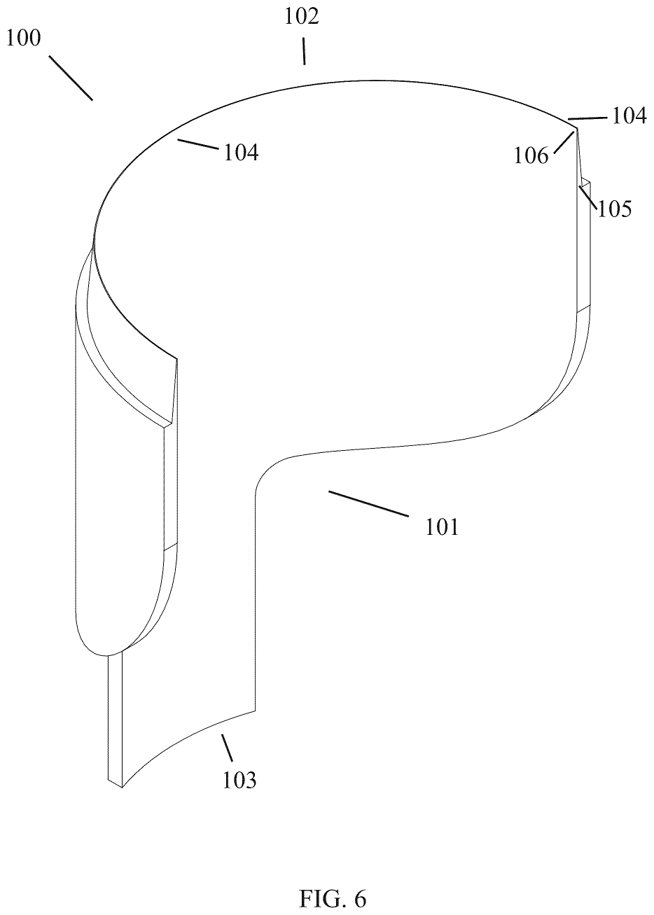

FIG. 7 is a front elevation view for an embodiment of the present invention, wherein a tapered fixture edge has been incorporated without a flat barrier.

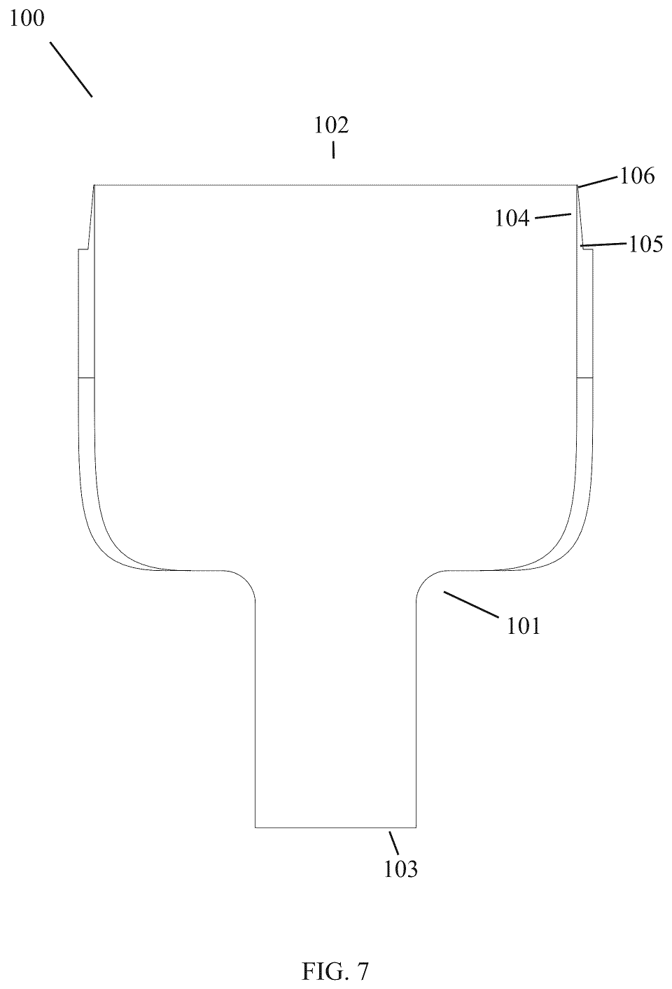

FIG. 8 is a top rear perspective view for an embodiment of the present invention, wherein a handle has been incorporated into the device in an extended configuration.

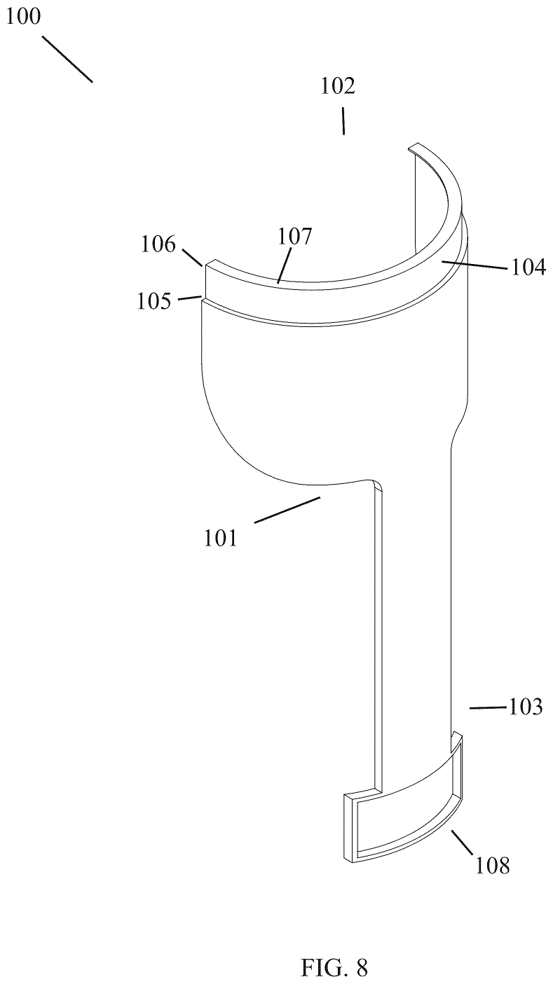

FIG. 9 is a rear elevation view for an embodiment of the present invention, wherein a handle has been incorporated into the device in an extended configuration.

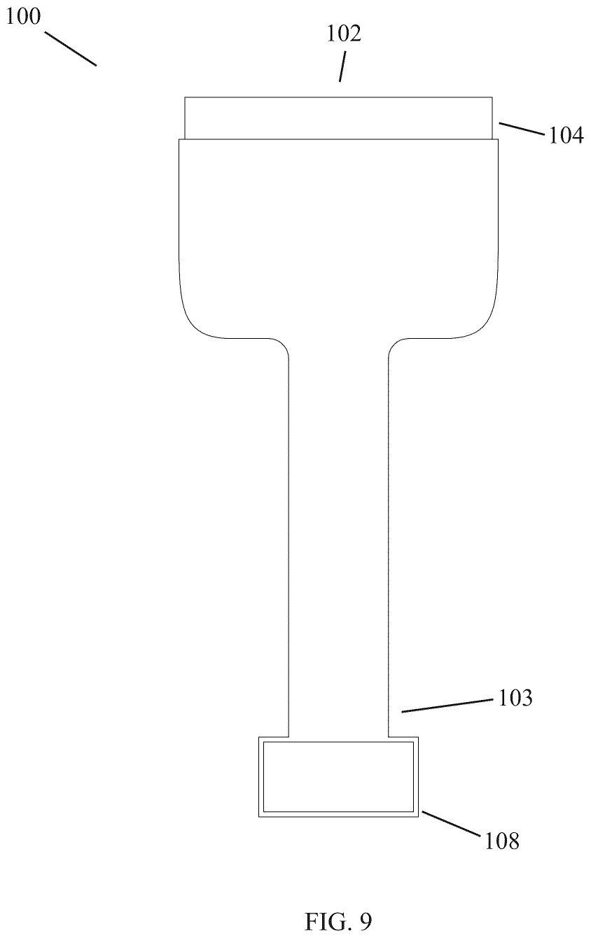

FIG. 10 is an illustration for an embodiment of the present invention, wherein the invention is depicted in use to protect the base of a light fixture during painting.

### DETAIL DESCRIPTIONS OF THE INVENTION

All illustrations of the drawings are for the purpose of describing selected versions of the present invention and are not intended to limit the scope of the present invention.

The present invention is a painting fixture barrier configured to be placed adjacent to a wall or ceiling fixture, creating a thin barrier around the fixture base, allowing for simple painting of the adjacent wall without applying paint to the fixture. The present invention comprises a main body and a fixture edge with some embodiments further comprising a handle.

The main body (101) of the painting fixture barrier (100) is a partially cylindrical shell comprising a fixture end (102) and an attachment end (103), oppositely positioned from one another about the main body (101). In order to avoid interference with any hanging portion of a fixture, the main body (101) is preferably a thin piece of material that tapers from the fixture end (102) to the attachment end (103). The fixture edge (104) of the painting fixture barrier (100) is attached to the fixture end (102) of the main body (101) and comprises a base end (105) and a wall end (106), the base end (105) positioned against the main body (101) and the wall end (106) extending outward from the main body (101). The fixture edge (104) is partially circular in shape and has an edge thickness less than the thickness of the main body.

In some other embodiments, the fixture edge (104) tapers from the base end (105) to the wall end (106), making the edge thickness at the wall end less than the edge thickness at the base end. In other embodiments, the fixture edge (104) may further comprise a flat barrier (107). For those embodiments, the flat barrier (107) would be a flexible material extending inwardly, perpendicular to the fixture edge (104), configured to fit tightly around the fixture to create a secure painting boundary.

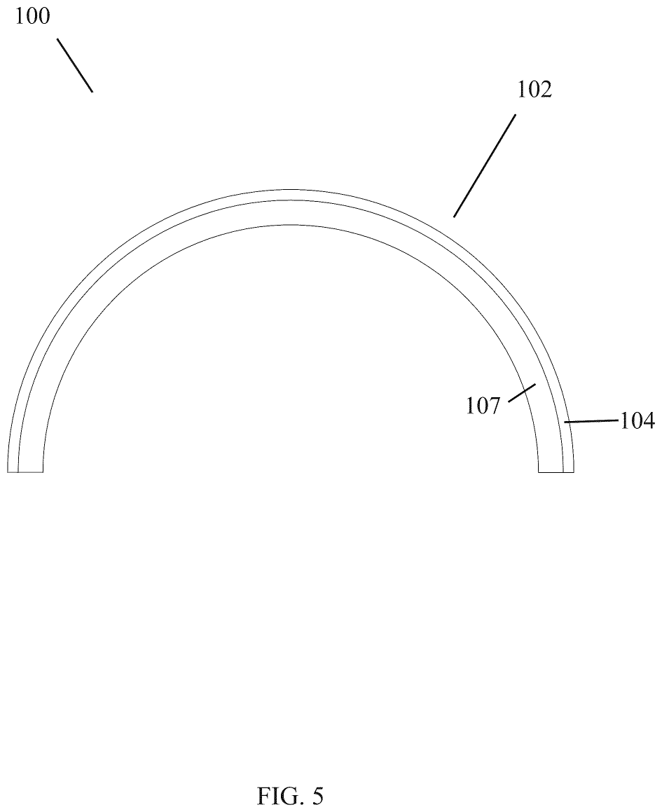

As shown in FIG. 5, the fixture edge (104) is preferably semicircular in shape, having an arc length of ˜180°, to allow placement along the circular edge of a fixture, but in some embodiments, the fixture edge (104) may run less than 180°, covering less than half of a circular fixture. Further, the present invention is not limited to partially circular embodiments and may also be shaped for rectangular, oval, or other shaped fixtures. The fixture edge (104) is preferably made of metal but may be plastic or other rigid materials in alternative embodiments. The fixture edge (104) may be constructed in shape, size, and material such that is flexible to bend and accommodate fixtures having shapes that are not precisely circular.

In a typical embodiment, the device will further comprise a handle (108). The handle (108) is connected to the attachment end (103) of the main body (101) and is configured to be held by the user, supporting the main body (101) and the fixture edge (104). The handle is preferably an elongated member extending directly opposite the fixture end (102) of the main body (101), though the handle (108) may extend away from the main body (101) at an angle.

Embodiments of the device (100) may further comprise an extended configuration wherein the attachment end (103) protrudes further from the fixture end (102) before reaching a handle (108), effectively extending the distance from which the device (100) can be deployed. The extended configuration allows the user to deploy the painting fixture barrier from further distances, for example reaching a fixture base on a ceiling while standing on the floor. The length of the extended configuration may vary depending on the embodiment. In some embodiments, the present invention may further comprise one or more hinged positions along the main body (101) toward the attachment end (103) and any handle (108), particularly for a device with an extended configuration, allowing the device to be folded for easier storage. For some embodiments, the extended configuration may be a removable component, wherein an extension would connect to the attachment end (103) of the main body (101) and a handle (108) would connect to either the attachment end (103) or the extension component.

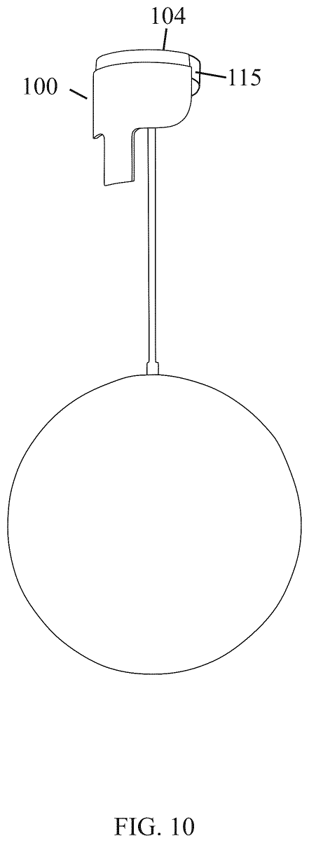

FIG. 10 depicts the device in a deployed state. The fixture edge (104) has been placed along the outside of a fixture (115). The fixture edge (104) of the device (100) is pressed against the fixture (115), ensuring that no significant gaps exist between the fixture (115) and the fixture edge (104). The user may then paint the wall or ceiling adjacent to the device (100), on the opposite side of the fixture. Since the device (100) is generally semi-circular, the fixture edge (104) may be repositioned along the fixture (115) one or more times in order to paint the entire wall or ceiling area around the fixture (115). Throughout this process, the user may hold the painting fixture barrier by a handle. In some embodiments, additional devices may be used simultaneously to fully surround a fixture, eliminating the need to readjust the fixture edge along the fixture during use. After use, the painting fixture barrier may be washed to remove paint, then the extender may be removed and/or the handle may be folded into the main body for storage.

Although the invention has been explained in relation to its preferred embodiment, it is to be understood that many other possible modifications and variations can be made without departing from the spirit and scope of the invention.

1. A paint barrier apparatus, the apparatus comprising:
A main body comprising a fixture end and an attachment end;
A fixture edge comprising a wall end and a base end;
wherein
The main body is formed in a partial semi-cylindrical shape with the fixture end extended away from the attachment end;
The main body is formed to a rigid structure;
The fixture edge is of lesser thickness than the main body;
The base end of the fixture edge is attached along the curved edge on the fixture end of the main body; and
The fixture edge extends away from the main body until it reaches the wall end.

2. The apparatus of claim 1, wherein the fixture edge is tapered down from the base end until reaching the wall end.

3. The apparatus of claim 1, wherein the fixture edge further comprises a flat barrier and wherein the flat barrier is positioned perpendicular to the fixture edge, is attached along the wall end of the fixture edge, and extends inward from the wall end of the fixture edge.

4. The apparatus of claim 1, wherein the fixture edge is formed to a rigid structure.

5. The apparatus of claim 4, wherein the fixture edge is formed to a flexible structure.

6. The apparatus of claim 1, wherein the apparatus further comprises a handle and the handle may be removably attached to the attachment end of the main body.

7. The apparatus of claim 6, wherein the apparatus further comprises of an extension component wherein the extension component removably attaches to the attachment end of the main body and wherein the handle may further be removably attached to the extension component, positioned opposite the location where the component attaches to the main body.

8. The apparatus of claim 7, wherein the extension component and handle may be folded along the length of the main body.

9. The apparatus of claim 1, wherein the apparatus further comprises a handle and the handle is affixed to the attachment end of the main body.

10. The apparatus of claim 9, wherein the handle may be folded along the length of the main body.

11. A paint barrier apparatus, the apparatus comprising:
A main body comprising a fixture end and an attachment end;
A fixture edge comprising a wall end and a base end;
wherein
The main body is formed in a partial tubed-polygonal shape with the fixture end extended away from the attachment end;
The main body is formed to a rigid structure;
The fixture edge is of lesser thickness than the main body;
The base end of the fixture edge is attached along the curved edge on the fixture end of the main body; and
The fixture edge extends away from the main body until it reaches the wall end.

12. The apparatus of claim 10, wherein the fixture edge is tapered down from the base end until reaching the wall end.

13. The apparatus of claim 10, wherein the fixture edge further comprises a flat barrier and wherein the flat barrier is positioned perpendicular to the fixture edge, is attached along each side of the wall end of the fixture edge, and extends inward from the wall end of the fixture edge.

14. The apparatus of claim 10, wherein the fixture edge is formed to a rigid structure.

15. The apparatus of claim 10, wherein the fixture edge is formed to a flexible structure.

16. The apparatus of claim 10, wherein the apparatus further comprises a handle and the handle may be removably attached to the attachment end of the main body.

17. The apparatus of claim 16, wherein the apparatus further comprises of an extension component wherein the extension component removably attaches to the attachment end of the main body and wherein the handle may further be removably attached to the extension component, positioned opposite the location where the component attaches to the main body.

18. The apparatus of claim 10, wherein the apparatus further comprises a handle and the handle is affixed to the attachment end of the main body.

19. A paint barrier apparatus, the apparatus comprising:
A main body comprising a fixture end and an attachment end;
A fixture edge comprising a wall end and a base end;
wherein
The main body is formed in a partial tubular irregular shape with the fixture end extended away from the attachment end;
The main body is formed to a rigid structure;
The fixture edge is of lesser thickness than the main body;
The base end of the fixture edge is attached along the curved edge on the fixture end of the main body; and
The fixture edge extends away from the main body until it reaches the wall end.

20. The apparatus of claim 19, wherein the fixture edge is formed to a flexible structure.
